(19) United States
(12) Patent Application Publication
(10) Pub. No.: US 2026/0087751 A1
(43) Pub. Date: Mar. 26, 2026

(54) INFORMATION DISPLAY SYSTEM, INFORMATION DISPLAY METHOD, AND PROGRAM

(71) Applicants: NEC Communication System, Ltd., Minato-ku, Tokyo (JP); NEC Corporation, Minato-ku, Tokyo (JP)

(72) Inventors: Yuri ADACHI, Tokyo (JP); Satoki UENO, Tokyo (JP); Masanori TAKAOKA, Tokyo (JP); Noriyuki AOKI, Tokyo (JP); Kenji KONO, Tokyo (JP); Naoki SAIKUSA, Tokyo (JP); Yuichi OZAKI, Tokyo (JP); Shoichi MOTOYAMA, Tokyo (JP); Takaaki SUGIO, Tokyo (JP); Manami KITAMURA, Tokyo (JP)

(73) Assignees: NEC Communication System, Ltd., Minato-ku, Tokyo (JP); NEC Corporation, Minato-ku, Tokyo (JP)

(21) Appl. No.: 19/109,716

(22) PCT Filed: Sep. 8, 2023
(86) PCT No.: PCT/JP2023/032907

§ 371 Date: Mar. 7, 2025

(30) Foreign Application Priority Data
Sep. 29, 2022 (JP) 2022-156277

(51) Int. Cl. G06T 19/00; G06T 7/60; G06T 7/70

(52) U.S. Cl. CPC G06T 19/006; G06T 7/60; G06T 7/70; G06T 2207/10028; G06T 2207/30244; G06T 2210/12; G06T 2210/56

(57) ABSTRACT

An information display system of the present disclosure includes: an acquiring unit that acquires position information of a display device displaying a real space image, an imaging device capturing an image of a predetermined target object, and the target object within a captured image captured by the imaging device; an aligning unit that makes a position of the target object within the captured image correspond to a position of the display device based on the position information; a generating unit that generates a virtual image of the target object based on the position information of the target object; and a display control unit that controls the display device to display the virtual image of the target object made to correspond to the position of the display device so as to be superimposed on the real space image.

### DESCRIPTION

### Technical Field

The present invention relates to an information display system, an information display method, and a program.

### Background Art

Under aviation law, an obstacle limitation surface is defined around an airport so that aircraft can take off and land safely. For this reason, in a determined space around an airport, the installation of a building and a tree protruding above the obstacle limitation surface is prohibited, and a surveillance operation for an object trespassing on the obstacle limitation surface is required.

Here, as an example of a system used for the surveillance operation, Patent Literature 1 describes a system using a head-mounted display. Specifically, in Patent Literature 1, three-dimensional structure data that depicts a surveillance target on a virtual three-dimensional space is stored first. Then, image data is collected from a camera installed in a surveillance target section, detection result data obtained by detecting an anomaly at the surveillance location is acquired from the image data, and positioning result data including position data and orientation data of the head-mounted display is acquired. After that, based on the three-dimensional structure data, the detection result data and the positioning result data, three-dimensional integrated data that integrates all the positional relations is generated, and a virtual image is displayed on the head-mounted display during the surveillance operation.

### CITATION LIST

### Patent Literature

Patent Literature 1: Japanese Unexamined Patent Application Publication No. JP-A 2012-239068

### SUMMARY OF INVENTION

### Technical Problem

However, the system described in Patent Literature 1 described above merely displays the result of detection of an anomaly in a surveillance target, and it is not easy for a surveillant to recognize the position of the surveillance target in a real space image. This causes a problem that the efficiency of the surveillance operation performed on site cannot be increased.

Accordingly, an object of the present disclosure is to provide an information display system that can solve the abovementioned problem that the efficiency of the surveillance operation performed on site cannot be increased.

### Solution to Problem

An information display system as an aspect of the present disclosure includes: an acquiring unit that acquires position information of a display device displaying a real space image, an imaging device capturing an image of a predetermined target object, and the target object within a captured image captured by the imaging device; an aligning unit that makes a position of the target object within the captured image correspond to a position of the display device based on the position information; a generating unit that generates a virtual image of the target object based on the position information of the target object; and a display control unit that controls the display device to display the virtual image of the target object made to correspond to the position of the display device so as to be superimposed on the real space image.

Further, an information display method as an aspect of the present disclosure includes: acquiring position information of a display device displaying a real space image, an imaging device capturing an image of a predetermined target object, and the target object within a captured image captured by the imaging device; making a position of the target object within the captured image correspond to a position of the display device based on the position information; generating a virtual image of the target object based on the position information of the target object; and controlling the display device to display the virtual image of the target object made to correspond to the position of the display device so as to be superimposed on the real space image.

Further, a computer program as an aspect of the present disclosure includes instructions for causing a computer to execute processes to: acquire position information of a display device displaying a real space image, an imaging device capturing an image of a predetermined target object, and the target object within a captured image captured by the imaging device; make a position of the target object within the captured image correspond to a position of the display device based on the position information; generate a virtual image of the target object based on the position information of the target object; and control the display device to display the virtual image of the target object made to correspond to the position of the display device so as to be superimposed on the real space image.

### Advantageous Effects of Invention

With the configurations as described above, the present disclosure can increase the efficiency of the surveillance operation performed on site.

### BRIEF DESCRIPTION OF DRAWINGS

FIG. 1 is a view showing the overview of an information display system in a first example embodiment of the present disclosure.

FIG. 2 is a view showing an example of a display image on a user terminal disclosed in FIG. 1.

FIG. 3 is a view showing an example of alignment between the user terminal and an imaging device disclosed in FIG. 1.

FIG. 4 is a block diagram showing an overall configuration of the information display system disclosed in FIG. 1.

FIG. 5 is a block diagram showing a configuration of the user terminal disclosed in FIG. 1.

FIG. 6 is a block diagram showing a configuration of an information processing server disclosed in FIG. 1.

FIG. 7 is a flowchart showing the operation of the information processing server disclosed in FIG. 1.

FIG. 8 is a flowchart showing the operation of the user terminal disclosed in FIG. 1.

FIG. 9 is a view showing another example of the display image on the user terminal disclosed in FIG. 1.

FIG. 10 is a view showing another example of the display image on the user terminal disclosed in FIG. 1.

FIG. 11 is a block diagram showing a hardware configuration of an information display system in a second example embodiment of the present disclosure.

FIG. 12 is a block diagram showing a configuration of the information display system in the second example embodiment of the present disclosure.

### DESCRIPTION OF EXAMPLE EMBODIMENTS

### First Example Embodiment

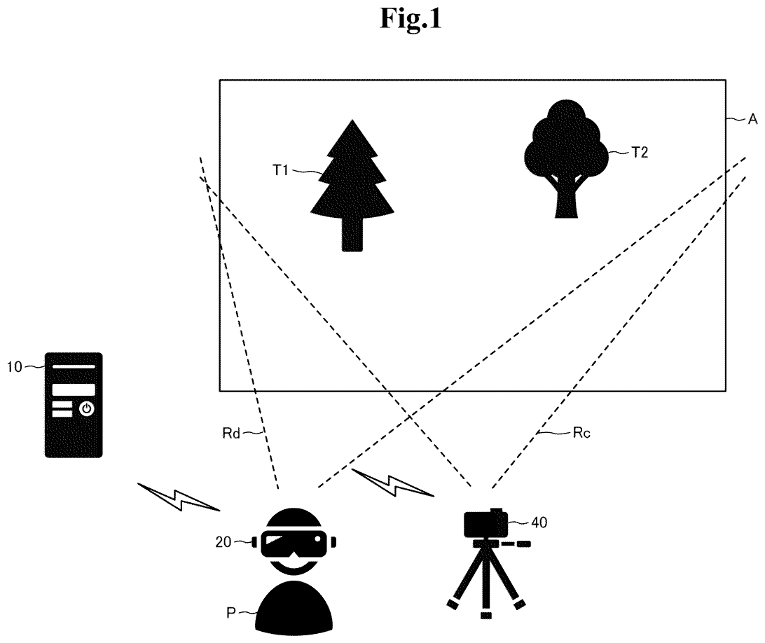

A first example embodiment of the present disclosure will be described with reference to FIGS. 1 to 10. First, the overview of an information display system in this example embodiment will be described.

### [Outline]

As shown in FIG. 1, an information processing system in this example embodiment includes a user terminal 20 that is a display device used by a user P, a sensor 40 that is an imaging device that captures an image of a predetermined target object, and an information processing server 10 that processes a displayed image. The information processing system 10 according to this example embodiment is used by the user P to watch for a building and a tree protruding from an obstacle limitation surface around an airport. For example, as shown in FIG. 1, the user P wears the user terminal 20 composed of a head-mounted display and watches an area around the airport, which is a place to watch for, through the user terminal 20. Then, on a display unit A of the user terminal 20 that is a head-mounted display, a real space image as shown in a range denoted by reference symbol Rd shown in FIG. 1 is displayed. A real space image displayed on the user terminal 20 may be an image obtained by seeing a real space through the display unit A, or may be an image obtained by converting a real space into digital data and displayed on the display unit A.

Then, the sensor 40 acquires imaging data 30 that is a captured image as shown in a range denoted by reference symbol Rc in FIG. 1 in the area around the airport. As will be described later, the imaging data 30 contains three-dimensional point cloud data that is position information indicating the three-dimensional coordinates of trees T1 and T2, which are target objects to watch for existing in an imaging range. The imaging data 30 is transmitted to the information processing server 10 via the user terminal 20 or directly from the imaging device 40.

The information processing server 10 generates virtual images V1 and V2 corresponding to the respective target objects from the three-dimensional point cloud data contained in the imaging data 30 captured by the sensor 40. Moreover, the information processing server 10 acquires the position information of the user terminal 20 and the sensor 40, and performs alignment therebetween. That is to say, based on the difference in positions between the user terminal 20 and the sensor 40, the information processing server 10 performs alignment so as to make the position of the imaging data 30 captured by the sensor 40 correspond to the position of the user terminal 20. Then, the information processing server 10 transmits the virtual images V1 and V2 based on the aligned imaging data 30 to the user terminal 20, and controls to display so that the virtual images V1 and V2 are superimposed on the real space image shown on the user terminal 20.

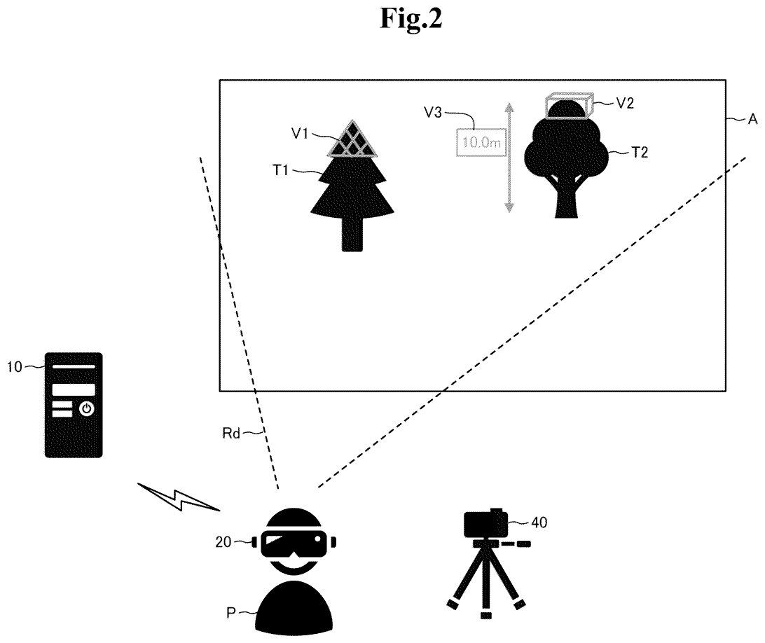

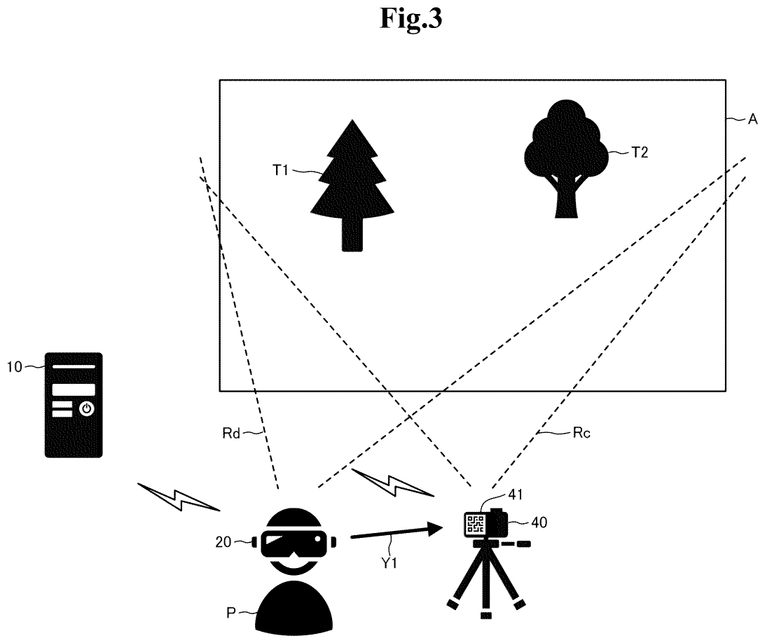

Consequently, the aligned virtual images V1 and V2 on the real space image of the range denoted by reference symbol Rd are displayed on the display unit A of the user terminal 20 as shown in FIG. 2. In the following, the respective components and operations will be described in detail with reference to FIGS. 3 to 10.

### [Configuration]

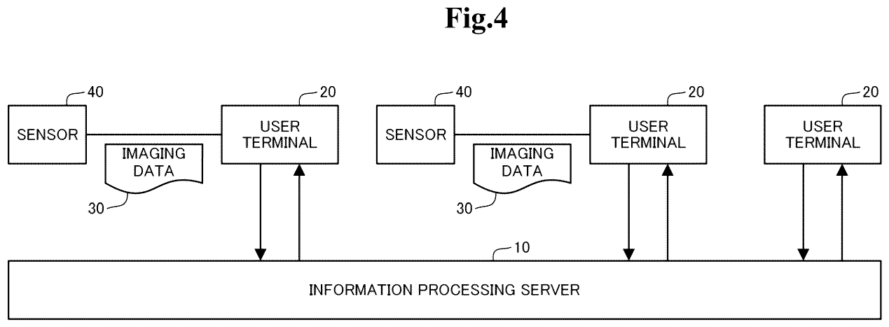

FIG. 4 is a system configuration view of the entire information processing system. The user terminal 20 acquires the imaging data 30 captured by the sensor 40, and mutually links data with another user terminal 20 in real time through the information processing server 10.

The sensor 40 is a 3D sensor (three-dimensional sensor) such as a LIDAR (Light Detection and Ranging, Laser Imaging Detection and Ranging) camera, a ToF (Time of Flight) camera, and a stereo camera. However, the sensor 40 is not limited to a 3D sensor, and may be a hyperspectral camera, an RGB camera, or other sensors.

The user terminal 20 is MR Glasses (Mixed Reality Glasses) such as a head-mounted display. Therefore, the user terminal 20 is configured to be able to display a real space image and also display virtual image data superimposed on the real space image. Meanwhile, the user terminal 20 is not limited to being MR Glasses, and may be any other glasses-type device such as VR Glasses (Virtual Reality Glasses) or may be any information processing terminal having a display unit, such as a personal computer, a tablet computer, and a smartphone. The user terminal 20 may be carried by the user or may be a system that is on site and exchanges information with the user (e.g., a system that can present information to the user with a projector and acquires information from the user with a sensor or voice).

The user terminal 20 may not have the sensor 40 and not directly acquire the imaging data 30, but may acquire data only from the information processing server 10. That is to say, the user terminal 20 may be connected to the sensor 40 that captures the imaging data 30 and display on the head-mounted display described above. In the following, the configuration of the user terminal 20 connected to the sensor 40 will be mainly described.

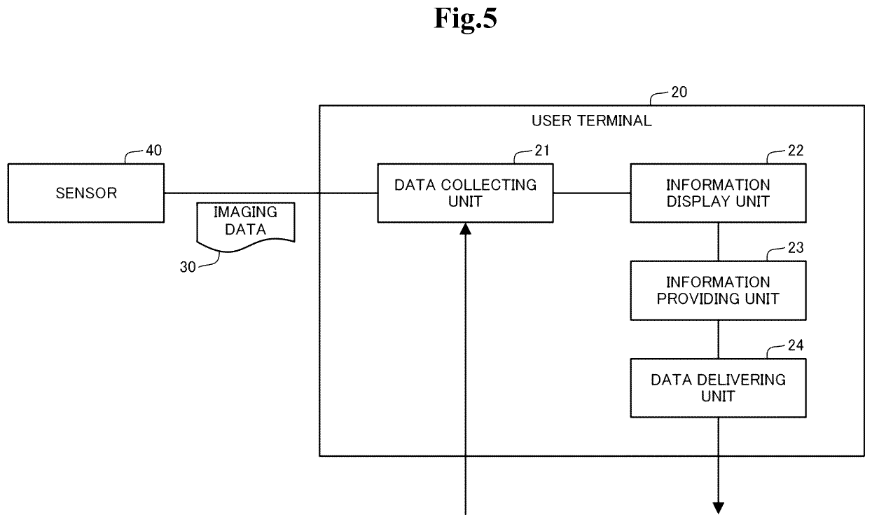

FIG. 5 is a system configuration diagram of the user terminal 20. The user terminal 20 is composed of an information processing terminal including an arithmetic logic unit, a memory unit, and a display unit. Then, the user terminal 20 includes a data collecting unit 21, an information display unit 22, an information providing unit 23 and a data delivering unit 24 as shown in FIG. 5. The respective functions of the data collecting unit 21, the information display unit 22, the information providing unit 23 and the data delivering unit 24 can be implemented by the arithmetic logic unit executing a program for implementing the respective functions stored in the memory unit.

The data collecting unit 21 acquires the imaging data 30 acquired by the sensor 40 described above and data such as a virtual image stored in the information processing server 10. The data collecting unit 21 also acquires the position information of the user terminal 20 and the position information of the sensor 40. For example, the data collecting unit 21 acquires position information including the position and imaging direction of the user terminal 20 from a GPS (Global Positioning System) device and an orientation sensor installed in the user terminal 20. The data collecting unit 21 also acquires position information including the position and imaging direction of the sensor 40 from a GPS device and an orientation sensor installed in the sensor 40 via the user terminal 20. As shown by reference symbol Y1 in FIG. 3, the data collecting unit 21 may capture a QR code 41 displayed on the sensor 40 with a camera mounted on the user terminal 20, and acquire identification information of the sensor 40 contained in the QR code 41. At this time, it is assumed that the position information including the position and imaging direction of the sensor 40 is associated in advance with the identification information of the sensor 40. Meanwhile, the QR code 41 itself may contain the position information of the sensor 40.

The information display unit 22 controls to display information acquired by the data collecting unit 21 on the display unit A. For example, the information display unit 22 displays by superimposing (overlaying) data such as the virtual image transmitted from the information processing server 10 on the displayed real space image seen through the display unit A or converted into digital data as will be described later. For example, as will be described later, the virtual image is information generated based on three-dimensional point cloud data, such as mesh data and a bounding box that simplify the shapes of target objects such as the trees T1 and T2 existing in the real space, specifically, information generated by compressing the three-dimensional point cloud data. The information display unit 22 can use external data to depict a space or an object and can display in an easy-to-understand manner using an avatar, a viewpoint and the like so that the user's position and orientation within the space can be understood, on the display unit A, but the method of display is not limited to the above. Moreover, the information display unit 22 may not only display the point cloud data and the mesh data, but also superimpose (overlay) them to make it easier to see, switch them, adjust the overlap thereof, and choose the display.

The information providing unit 23 performs update and edit of the data acquired by the data collection unit 21, generation of information from another function (camera, GPS, IMU sensor, etc.) of the user terminal 20, independent generation of information by the user P, and the like. For example, the information providing unit 23 generates information such as a QR code captured with the camera as described above, that is, identification information of the sensor 40, and information of the positional relation between the position information of the sensor 40 and the position information of the user terminal 20. The information providing unit 23 may also perform preprocessing such as noise reduction, outlier removal, and correction on the imaging data 30.

The data delivering unit 24 transmits the abovementioned imaging data 30, the position information, the generated information and so forth to the information processing server 10, and stores into the information processing server 10. The delivery of the imaging data and so forth may be performed with all the data or the difference data alone every time the imaging data and so forth is acquired, and throttling, timing adjustment and the like may be performed in consideration of the transmission load.

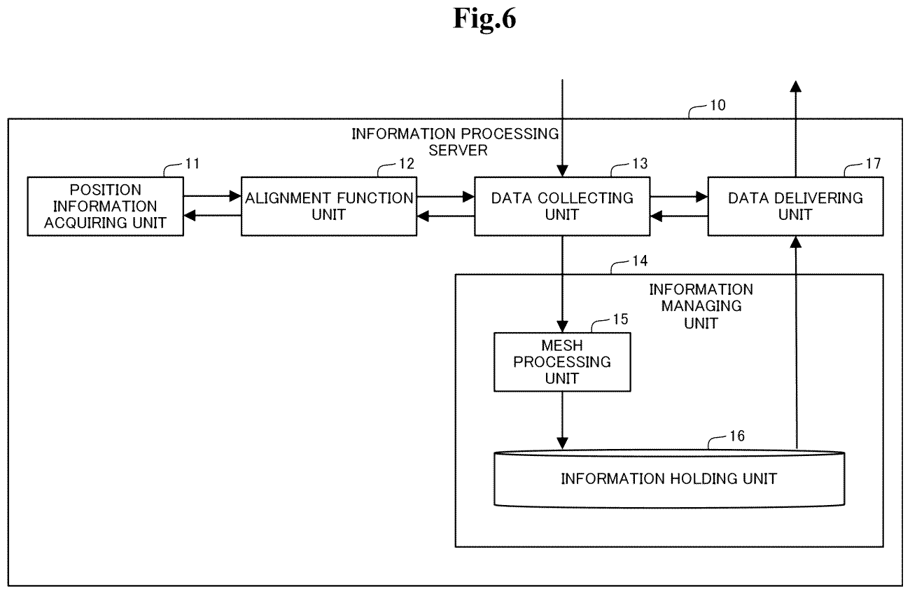

FIG. 6 is a system configuration diagram of the information processing server 10. The information processing server 10 is configured with one or a plurality of information processing apparatuses each including an arithmetic logic unit and a memory unit. Then, the information processing server 10 includes, as shown in FIG. 6, a position information acquiring unit 11, an alignment function unit 12, a data collecting unit 13, an information managing unit 14, and a data delivering unit 17. Moreover, the information managing unit 14 includes a mesh processing unit 15. The respective functions of the position information acquiring unit 11, the alignment function unit 12, the data collecting unit 13, the information managing unit 14, the mesh processing unit 15, and the data delivering unit 17 can be implemented by the arithmetic logic unit executing a program for implementing the respective functions stored in the memory unit. Moreover, the information managing unit 14 of the information processing server 10 includes an information holding unit 16. The information holding unit 16 is configured with the memory unit. In the following, the respective components will be described in detail.

First, the data collecting unit 13 collects data transmitted from the user terminal 20. For example, the data collecting unit 13 collects the position information of the user terminal 20 and the sensor 40, and collects the three-dimensional point cloud data of the imaging data 30 as the position information of a target object within the imaging data 30 captured with the sensor 40. The collected information is acquired by the position information acquiring unit 11 and used by the alignment function unit 12, and is passed to the mesh processing unit 15.

The position information acquiring unit 11 (acquiring unit) acquires the position information of the user terminal 20, the sensor 40, a target object within the imaging data 30, and so forth. For example, the position information acquiring unit 11 acquires the position information from the data obtained from the user terminal 20 and the information provided therefrom. As an example, the position information acquiring unit 11 acquires position information including the positions and imaging directions of the user terminal 20 and the sensor 40 from information obtained from the GPSs and the orientation sensors of the user terminal 20 and the sensor 40. The position information acquiring unit 11 also acquires position information composed of three-dimensional coordinates of a target object such as a tree shown in the imaging data 30 from the point cloud data of the imaging data 30. In a case where the identification information of the sensor 40 can be obtained from the QR code 41 of the sensor 40, the position information acquiring unit 11 acquires the position information of the sensor 40 associated with the identification information and stored in advance.

The alignment function unit 12 (aligning unit) performs alignment between the user terminal 20 and the sensor 40 based on the position information acquired as described above. Specifically, the alignment function unit 12 performs alignment so as to make the position of the imaging data 30 captured by the sensor 40 correspond to the position of the user terminal 20 based on the difference in positions between the user terminal 20 and the sensor 40. That is to say, the alignment function unit 12 makes the three-dimensional coordinates of the imaging data 30 acquired by the sensor 40 correspond to the position and imaging direction of the user terminal 20. At this time, the user terminal 20 to be aligned is not limited to the user terminal 20 connected to the sensor 40, and includes another user terminal 20 that is not connected to the sensor 40. By collecting the imaging data 30 acquired from a plurality of sensors 40 of identical or different types and aligning them with the respective user terminals 20, it is possible to align the imaging data 30 from the sensors 40 so as to conform without contradiction.

The mesh processing unit 15 (generating unit) of the information managing unit 14 generates compressed data obtained by converting the three-dimensional point cloud data of the imaging data 30 captured by the sensor 40 into a mesh, and stores into the information holding unit 16. Then, the stored compressed data is transmitted to each user terminal 20 by the data delivering unit 17 in response to a request from each user terminal 20.

Specifically, the mesh processing unit 15 generates a virtual image obtained by converting the three-dimensional point cloud data of target objects such as the trees T1 and T2 within the imaging data 30 into a mesh, a polygon, CAD data, and a bounding box. A target object converted into a mesh and the granularity are determined in accordance with an instruction from the user terminal 20 and other information. It is also possible to control the granularity of the imaging data 30 from the sensor 40 and the adjustment of the frame rate based on an instruction from the user terminal 20 and other information.

Further, the mesh processing unit 15 can select and change a target object to be compressed such as being converted into a mesh within the imaging data 30. For example, the mesh processing unit 15 may automatically detect a target object specified by the user terminal 20, for example, a “tree” from the imaging data 30, and generate a virtual image by converting the target object into a mesh. Moreover, in a case where a range or area for detecting a target object is defined by the user terminal 20, the mesh processing unit 15 may generate a virtual image of the target object solely in the range or area. Moreover, in a case where an object other than the target object, for example, “utility pole and building” are specified from the user terminal 20, the mesh processing unit 15 may exclude these objects, and convert the other object (tree, etc.) into a mesh. Moreover, the mesh processing unit 15 may measure the size of a target object such as a tree from the three-dimensional point cloud data, and generate a virtual image including the measurement value.

Further, the mesh processing unit 15 may determine a target object based on prediction/estimation. For example, the mesh processing unit 15 may measure the size of the target object as described above, and generate a virtual image of a portion of the target object predicted to trespass on the obstacle limitation surface in the future. The mesh processing unit 15 may generate a virtual image in which the predicted portion and an actually trespassing portion are displayed with different colors and shapes. Moreover, the mesh processing unit 15 may perform the mesh processing and the like in cooperation with an external system (CAD system, as-built drawing management system, drawing management system, GIS system, etc.). Moreover, the mesh processing unit 15 may, without limit a target converted into a mesh by distinguishing the target and others, determine the presence or absence of mesh and the granularity of mesh (accuracy such as the number of polygons and the number of calculations) by processing capacity, number of point clouds, density, accuracy, error, and the like. Moreover, the mesh processing unit 15 may determine a target to be converted into a mesh, the granularity of the conversion into a mesh, and the like, in accordance with an instruction from the user or in cooperation with external data. Moreover, the mesh processing unit 15 may hold a temporal history, and perform point cloud processing and mesh processing based on the history and a temporal change amount. Moreover, the mesh processing unit 15 may hold data converted into a mesh and data outside the target for conversion into a mesh, and use them for determining whether the presence or absence of a target for conversion into a mesh, object detection (target search, matching, etc.), and target tracking (tracking), and these functions make it possible to lighten and simplify point cloud processing. The mesh processing unit 15 may be installed in the user terminal 20 and transmit point cloud data, mesh, or both of them from the user terminal 20 to the information processing server 10.

The data delivering unit 17 (display control unit) transmits a virtual image generated by conversion into a mesh or a bounding box as described above to the user terminal 20. At this time, the data delivering unit 17 transmits the virtual image so that the virtual image is made to correspond to the position of the user terminal 20 described above and displayed on the display unit of the user terminal 20. Consequently, on the display unit of user terminal 20, as shown in FIG. 2, the virtual images V1 and V2 of mesh and bounding box are displayed so as to be superimposed at the positions of the trees T1 and T2 that are the target objects on the real space image are displayed, and a virtual image V3 including measured height information is displayed.

### [Operation]

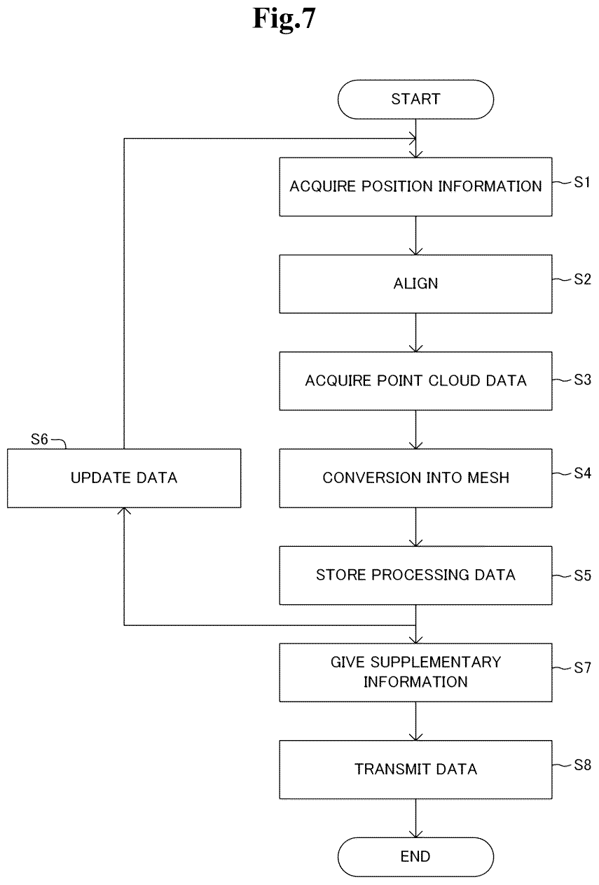

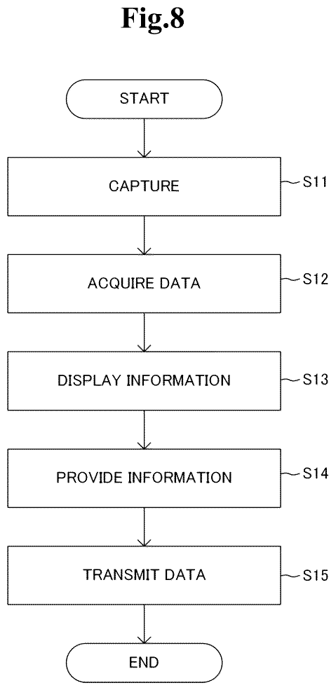

Next, the operation of the above information display system will be described with reference to flowcharts of FIGS. 7 to 8. First, the operation of the information processing server 10 will be described with reference to the flowchart of FIG. 7.

The information processing server 10 acquires position information (imaging position, imaging direction, setting and situation of imaging, supplementary information, etc.) of the user terminal 20 and the sensor 40 (step S1). Then, the information processing server 10 performs alignment between the sensor 40 and the user terminal 20 (step S2). Moreover, the information processing server 10 acquires point cloud data that is the imaging data 30 (step S3). At this time, the information processing server 10 makes the point cloud data correspond to the position of the user terminal 20 in accordance with the alignment described above. The information processing server 10 may perform coupling of point cloud data that the sensor 40 has captured while moving, synthesis (registration) of point cloud data captured by a plurality of sensors 40, and the like. When coupling several fields of view captured by a 3D sensor, the information processing server 10 also performs the alignment of point cloud data using the position information, external data, and the like. The alignment may be performed after a compression process such as conversion of three-dimensional point cloud data into a mesh.

Subsequently, the information processing server 10 generates a virtual image by performing conversion of three-dimensional point cloud data into a mesh, and the like, so that a portion trespassing on an obstacle limitation surface becomes clear (step S4). The information processing server 10 may generate a virtual image in which a normal portion is displayed as a target object, not limited to a portion trespassing on the obstacle limitation surface or a violation/anomaly portion, and may generate a virtual image in accordance with a purpose required by the user P. Processing such as conversion into a mesh may be performed not on the information processing server 10 but on the user terminal 20 on site. Moreover, the information processing server 10 may generate a virtual image in which a portion trespassing on the obstacle limitation surface is shown by placing a box (bounding box) instead of converting into a mesh, and may generate a virtual image in which an arrow or a pin-like shape is placed. In the point cloud processing and mesh processing, the information processing server 10 may perform pre-processing and post-processing such as noise reduction and correction.

Then, the information processing server 10 stores necessary processing data or all the processing data into the information holding unit 16 (step S5) and updates necessary data or all the data (step S6), so that it becomes possible to display real-time information on the user terminal 20 at all times. At this time, the information processing server 10 can adjust the granularity and accuracy of a virtual image and the like to be generated in accordance with an instruction from a person such as the user P, linkage with an external system, and determination of the real-time property of internal processing, resource security and the like, and display information in real time. Then, the information processing server 10 also generates a virtual image to which supplementary information such as a measurement value obtained by measuring the size of the target object is given as necessary (step S7) and transmits the virtual image to each user terminal 20 (step S8).

Subsequently, the operation of the user terminal 20 will be described with reference to the flowchart of FIG. 8. The user terminal 20 captures the imaging data 30 using the sensor 40 (step S11), and also acquires a virtual image generated by conversion into a mesh or a bounding box transmitted from the information processing server 10 (step S12). At this time, the user terminal 20 acquires position information and the like. Then, the user terminal 20 displays a real space image obtained through the display unit A or converted digitally, and also displays the acquired virtual image superimposed on the real space image (step S13). In a case where the user terminal 20 is not connected to the sensor 40, the process at step S11 may be omitted. In a case where the user terminal 20 generates the virtual image, the user terminal 20 may display the virtual image.

After that, the user terminal 20 may provide the imaging data 30 and the acquired data with information such as a message as necessary (step S14). Then, the user terminal 20 transmits to the acquired information such as the imaging data and the position information to the information processing server 10 (step S15).

As described above, according to this example embodiment, it is possible to acquire three-dimensional point cloud data of a tree and a building around an airport using an imaging device such as a 3D LIDAR, superimpose a virtual image that clearly shows a portion protruding from an obstacle limitation surface on a real space image, and display on the user terminal 20 such as MR glasses. As a result, it becomes easier to carry out inspection and surveillance under aviation law, and it becomes possible to improve the efficiency of a surveillance operation on site.

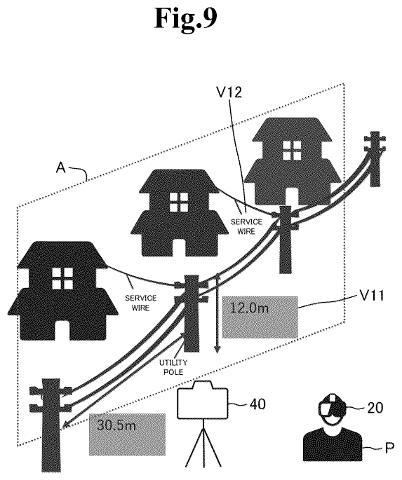

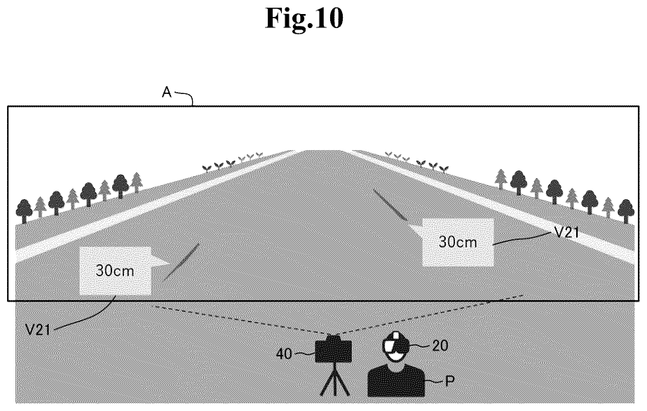

Another usage example of the above information display system will be described with reference to FIGS. 9 and 10. FIG. 9 shows a case of performing a surveillance operation such as separation measurement of utility poles, electrical cables and the like on a vast site.

As shown in FIG. 9, the user P goes to the site with the user terminal 20 on, and sees utility poles and electrical cables to be targets. Moreover, the three-dimensional sensor 40 captures an image of the site and, using three-dimensional point cloud data that is the imaging data, the information processing server (not shown) performs detection of the target utility poles and power lines and moreover measurement of the heights and intervals of the utility poles. The information processing server generates a virtual image composed of text information of “measurement values” and detected “electric poles” and “service wires”, and transmits to the user terminal 20. Consequently, as shown in FIG. 9, on the display unit A of the user terminal 20, a real space image obtained through the display unit A or converted digitally can be displayed, and virtual images V11 and V12 composed of text information of the measurement values and the target objects generated by the information server superimposed on the real space image can also be displayed.

Further, FIG. 10 shows a case of performing a surveillance operation to detect, for example, a crack in the ground at a vast place such as an airport, an expressway, and a national highway. The user P goes to the site with the user terminal 20 on, and sees the ground to be a target. Moreover, the sensor 40 such as 3D LIDAR captures an image of the site and, using three-dimensional point cloud data that is the imaging data, the information processing server (not shown) detects a crack in the ground and measures the length thereof. The information processing server generates a virtual image composed of text information of “measurement value” and transmits to the user terminal 20. Consequently, as shown in FIG. 10, on the display unit A of the user terminal 20, a real space image obtained through the display unit A or converted digitally can be displayed, and a virtual image V21 including the text information of the measurement value indicating the length of the crack generated by the information processing server superimposed on the real space image can also be displayed. The acquisition of the imaging data by the sensor 40 may be performed, for example, by a drone or a camera mounted on a vehicle.

### Second Example Embodiment

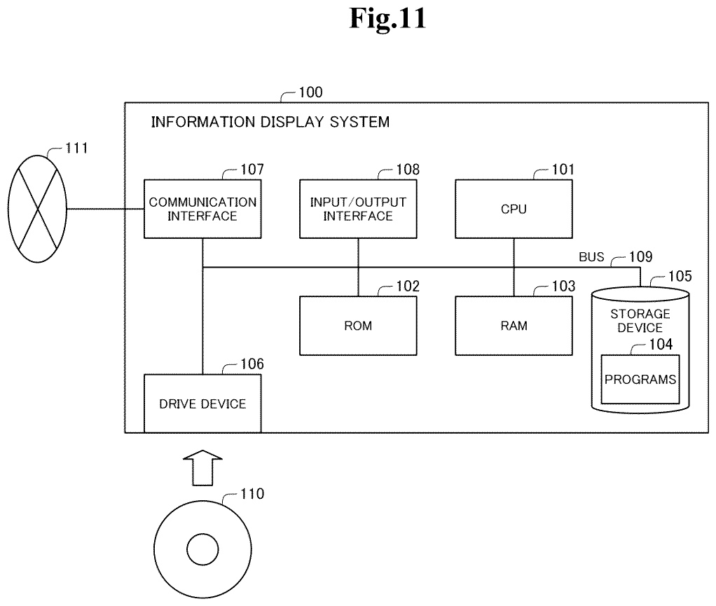

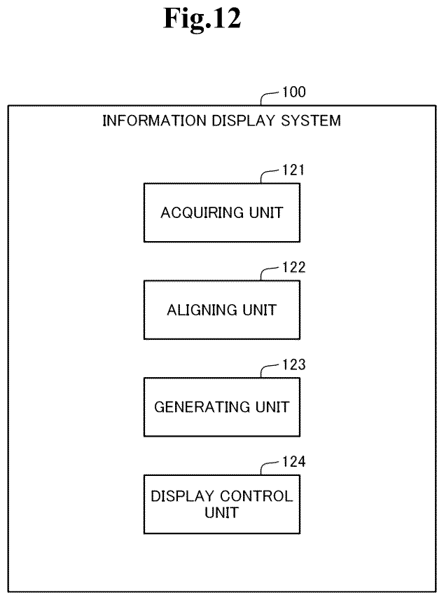

Next, a second example embodiment of the present disclosure will be described with FIGS. 11 and 12. FIGS. 11 and 12 are block diagrams showing the configuration of an information display system in the second example embodiment. In this example embodiment, the overview of the configuration of the information display system described in the above example embodiment will be shown.

First, with reference to FIG. 11, a hardware configuration of an information display system in this example embodiment will be described. The information display system 100 is configured with a general information processing apparatus and, as an example, has the following hardware configuration including
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 storing the programs 104,
a drive device 106 reading from and writing into a storage medium 110 outside the information processing apparatus,
a communication interface 107 connected to a communication network 111 outside the information processing apparatus,
an input/output interface 108 performing input/output of data, and
a bus 109 connecting the respective components.

FIG. 11 shows an example of the hardware configuration of the information processing apparatus serving as the information display system 100, and the hardware configuration of the information processing apparatus is not limited to the abovementioned case. The information processing apparatus may include part of the above configuration, for example, excluding the drive device 106. Moreover, the information processing apparatus can use, instead of the abovementioned CPU, a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof.

Then, the information display system 100 can structure and include an acquiring unit 121, an aligning unit 122, a generating unit 123 and a display control unit 124 shown in FIG. 12 by acquisition and execution of the programs 104 by the CPU 101. The programs 104 are, for example, stored in advance in the storage device 105 or the ROM 102, and loaded to the RAM 103 and executed by the CPU 101 as necessary. Moreover, the programs 104 may be delivered to the CPU 101 via the communication network 111, or may be stored in advance in the storage medium 110 and retrieved and delivered to the CPU 101 by the drive device 106. However, the acquiring unit 121, the aligning unit 122, the generating unit 123 and the display control unit 124 described above may be structured with a dedicated electronic circuit for implementing the above units.

The acquiring unit 121 acquires position information of a display device displaying a real space image, an imaging device capturing an image of a predetermined target object, and the target object within a captured image captured by the imaging device.

The aligning unit 122 makes a position of the target object within the captured image correspond to a position of the display device based on the position information.

The generating unit 123 generates a virtual image of the target object based on the position information of the target object. For example, by compressing the position information of the target object, the generating unit 123 generates a virtual image obtained by simplifying a shape of the target object.

The display control unit 124 controls the display device to display the virtual image of the target object made to correspond to the position of the display device so as to be superimposed on the real space image.

With the configuration as described above, the present disclosure aligns the position information of the imaging data captured using the imaging device so as to correspond to the position of the user terminal, and displays the virtual image of the target object within the imaging data superimposed on the real space image displayed on the user terminal. Consequently, the user can easily recognize the position and situation of the surveillance target on the real space image using the user terminal. As a result, it is possible to improve the efficiency of a surveillance operation on site.

The abovementioned programs can be stored and delivered to a computer using various types of non-transitory computer-readable mediums. Non-transitory computer-readable mediums include various types of tangible recording mediums. Examples of non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, and RAM (Random Access Memory)). The program may also be delivered to a computer by various types of transitory computer-readable mediums. Examples of transitory computer-readable mediums include electrical signals, optical signals, and electromagnetic waves. The transitory computer-readable medium can deliver the program to a computer via a wired communication path such as an electric wire and optical fiber or a wireless communication path.

Although the present disclosure has been described above with reference to the example embodiments and so forth, the present disclosure is not limited to the above example embodiments. The configurations and details of the present disclosure can be changed in various manners that can be understood by one skilled in the art within the scope of the present disclosure. Moreover, at least one or more of the functions of the acquiring unit 121, the aligning unit 122, the generating unit 123 and the display control unit 124 described above may be executed by an information processing apparatus installed in any place on the network and connected, that is, may be executed on so-called cloud computing.

### Supplementary Notes

The whole or part of the example embodiments disclosed above can be described as the following supplementary notes. In the following, the overview of the configurations of an information display system, an information display method and a program according to the present disclosure will be described. However, the present disclosure is not limited to the following configurations.

### (Supplementary Note 1)

An information display system comprising:
an acquiring unit that acquires position information of a display device displaying a real space image, an imaging device capturing an image of a predetermined target object, and the target object within a captured image captured by the imaging device;
an aligning unit that makes a position of the target object within the captured image correspond to a position of the display device based on the position information;
a generating unit that generates a virtual image of the target object based on the position information of the target object; and
a display control unit that controls the display device to display the virtual image of the target object made to correspond to the position of the display device so as to be superimposed on the real space image.

### (Supplementary Note 2)

The information display system according to Supplementary Note 1, wherein
the generating unit generates the virtual image by compressing the position information of the target object.

### (Supplementary Note 3)

The information display system according to Supplementary Note 2, wherein
the generating unit generates the virtual image by simplifying a shape of the target object.

### (Supplementary Note 4)

The information display system according to Supplementary Note 2, wherein
the generating unit generates the virtual image only for the target object satisfying a previously set criterion within the captured image.

### (Supplementary Note 5)

The information display system according to Supplementary Note 2, wherein:
the captured image captured by the imaging device is point cloud data including three-dimensional coordinates of the target object; and
the generating unit generates the virtual image by converting the point cloud data of the target object into a mesh, a polygon, or a bounding box.

### (Supplementary Note 6)

The information display system according to Supplementary Note 2, wherein:
the captured image captured by the imaging device is point cloud data containing three-dimensional coordinates of the target object; and
the generating unit measures a size of the target object based on the position information of the target object, and generates the virtual image including a measurement value.

### (Supplementary Note 7)

The information display system according to Supplementary Note 1, wherein
the acquiring unit acquires, from the display device, identification information of the imaging device acquired by the display device together with the position information of the display device, and acquires position information of the imaging device associated in advance with the identification information of the imaging device.

### (Supplementary Note 8)

An information display method comprising:
acquiring position information of a display device displaying a real space image, an imaging device capturing an image of a predetermined target object, and the target object within a captured image captured by the imaging device;
making a position of the target object within the captured image correspond to a position of the display device based on the position information;
generating a virtual image of the target object based on the position information of the target object; and
controlling the display device to display the virtual image of the target object made to correspond to the position of the display device so as to be superimposed on the real space image.

### (Supplementary Note 9)

A computer program comprising instructions for causing a computer to execute processes to:
acquire position information of a display device displaying a real space image, an imaging device capturing an image of a predetermined target object, and the target object within a captured image captured by the imaging device;
make a position of the target object within the captured image correspond to a position of the display device based on the position information;
generate a virtual image of the target object based on the position information of the target object; and
control the display device to display the virtual image of the target object made to correspond to the position of the display device so as to be superimposed on the real space image.

This application is based upon and claims the benefit of priority from Japanese patent application No. 2022-156277, filed on Sep. 29, 2022, the disclosure of which is incorporated herein in its entirety by reference.

### REFERENCE SIGNS LIST

10 information processing server
11 position information acquiring unit
12 alignment function unit
13 data collecting unit
14 information managing unit
15 mesh processing unit
16 information holding unit
17 data delivering unit
20 user terminal
21 data collecting unit
22 information display unit
23 information providing unit
24 data delivering unit
30 imaging data
40 sensor
100 information display system
101 CPU
102 ROM
103 RAM
104 programs
105 storage device
106 drive device
107 communication interface
108 input/output interface
109 bus
110 storage medium
111 communication network
121 acquiring unit
122 aligning unit
123 generating unit
124 display control unit

What is claimed is:

1. An information display system comprising:
at least one memory storing processing instructions; and
at least one processor configured to execute the processing instructions to:
acquire position information of a display device displaying a real space image, an imaging device capturing an image of a predetermined target object, and the target object within a captured image captured by the imaging device;
make a position of the target object within the captured image correspond to a position of the display device based on the position information;
generate a virtual image of the target object based on the position information of the target object; and
control the display device to display the virtual image of the target object made to correspond to the position of the display device so as to be superimposed on the real space image.

2. The information display system according to claim 1, wherein the at least one processor is configured to execute the processing instructions to
generate the virtual image by compressing the position information of the target object.

3. The information display system according to claim 2, wherein the at least one processor is configured to execute the processing instructions to
generate the virtual image by simplifying a shape of the target object.

4. The information display system according to claim 2, wherein the at least one processor is configured to execute the processing instructions to
generate the virtual image only for the target object satisfying a previously set criterion within the captured image.

5. The information display system according to claim 2, wherein:
the captured image captured by the imaging device is point cloud data including three-dimensional coordinates of the target object; and
the at least one processor is configured to execute the processing instructions to generate the virtual image by converting the point cloud data of the target object into a mesh, a polygon, or a bounding box.

6. The information display system according to claim 2, wherein:
the captured image captured by the imaging device is point cloud data containing three-dimensional coordinates of the target object; and
the at least one processor is configured to execute the processing instructions to measure a size of the target object based on the position information of the target object, and generate the virtual image including a measurement value.

7. The information display system according to claim 1, wherein the at least one processor is configured to execute the processing instructions to
acquire, from the display device, identification information of the imaging device acquired by the display device together with the position information of the display device, and acquire position information of the imaging device associated in advance with the identification information of the imaging device.

8. An information display method comprising:
acquiring position information of a display device displaying a real space image, an imaging device capturing an image of a predetermined target object, and the target object within a captured image captured by the imaging device;
making a position of the target object within the captured image correspond to a position of the display device based on the position information;
generating a virtual image of the target object based on the position information of the target object; and
controlling the display device to display the virtual image of the target object made to correspond to the position of the display device so as to be superimposed on the real space image.

9. A non-transitory computer-readable medium storing a program, the program comprising instructions for causing a computer to execute processes to:
acquire position information of a display device displaying a real space image, an imaging device capturing an image of a predetermined target object, and the target object within a captured image captured by the imaging device;
make a position of the target object within the captured image correspond to a position of the display device based on the position information;
generate a virtual image of the target object based on the position information of the target object; and
control the display device to display the virtual image of the target object made to correspond to the position of the display device so as to be superimposed on the real space image.
